(19) United States
(12) Patent Application Publication
(10) Pub. No.: US 2011/0095211 A1
(43) Pub. Date: Apr. 28, 2011

(54) Stealth Detection

(76) Inventor: Chi Hong Le, Liverpool, NY (US)

(21) Appl. No.: 12/607,973

(22) Filed: Oct. 28, 2009

(51) Int. Cl. H01J 40/14

(52) U.S. Cl. 250/578.1

(57) ABSTRACT

Use phase array laser or hybrid phase array to detect stealth object such as stealth airplane, ship, and low fly object that conventional radar cannot detect.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

### Field of Invention

this invention relates generally to radar. RF radar is hardly to detect stealthy airplane, ship, and low fly object a few feet above sea level. Therefore, new concept come out to use phase array laser interlace with RF phase array radar to detect stealthy objects.

### BRIEF SUMMARY OF THE INVENTION

The conventional radar hardly detects stealth aircraft, cruise missiles and low fly torpedoes a few meters above sea level. Therefore, use phase array laser to scan by transmit laser beam pulses, if hit object, then the laser light will be reflect back to the source from phase array that have sensor receiver. The hybrid phase array is interlace between RF and Laser, when RF pulses and Laser pulses are hit object at the same points and the same time, the RF will be resonant, so create more RF reflection.

### BRIEF DESCRIPTION OF THE SEVERAL VIEWS OF THE DRAWING

FIG. 1, Phase array laser have both transmitter and receiver. The functional operations are the same as concept conventional phase array radar that use radio frequencies, but here use laser lights. Phase array laser is high resolution, and measure the distance accuracy, therefore very good for conflict warning.

Know GPS location of the phase array laser, angle and distance from laser to target, use trig-math then know target position, direction, speed that pass information to guide missile or laser gun to shoot down the target.

Adjustable phase array laser power create heat feel like burn to control crowd, high power can kill people.

Due to limitation of laser in bad weather as rain, cloud, reduce the range of detection, so combine phase array laser with conventional phase array radar as shown FIG. 2, to become hybrid phase array radar, and use more phase array to form hybrid phase array radar network as FIG. 3 are better in detection and track the flying objects, and also avoid missiles attack by alternative on/off between radar site, missiles that use home coming RF or Laser will confuse which one the target, finally they are destination in somewhere between the radar sites. While the missiles guide by GPS, their fly path is very predictable, the radars are mobilized to the other locations because the radar are mount the truck. In the case can not avoid the missiles attack, and then send the missiles up to intercept them.

### DETAILED DESCRIPTION OF THE INVENTION

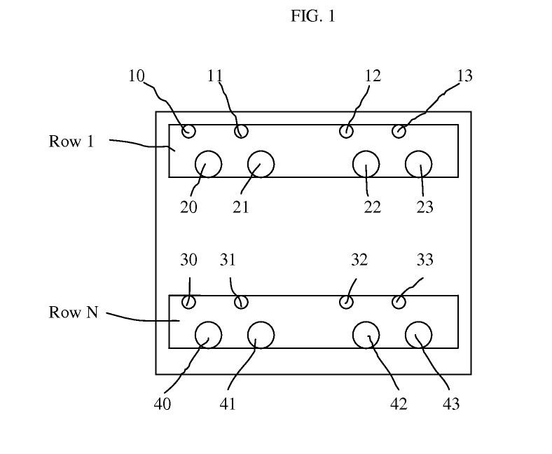

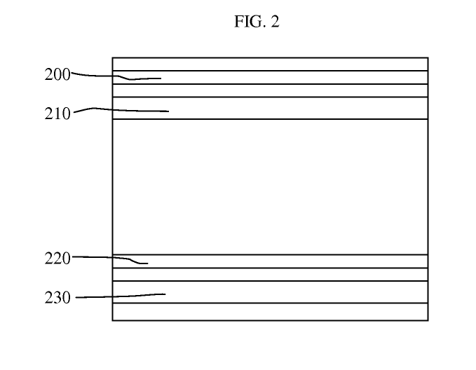

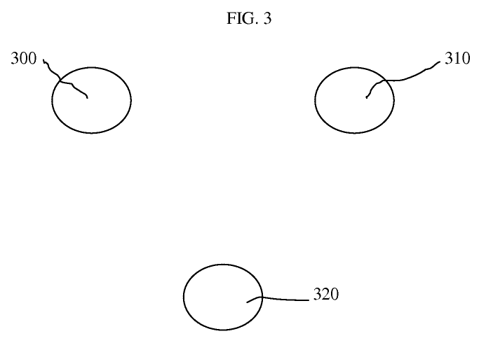

FIG. 1, Row 1 transmitter has: 10 is the first element laser transmitter, 11 is the second element laser transmitter, 12 is (M-1) element laser transmitter, and 13 is M element laser transmitter of row 1.

FIG. 1, Row 1 receiver has: 20 is the first element laser receiver, 21 is the second element laser receiver, 22 is (M-1) element laser receiver, and 23 is M element laser receiver of row 1.

FIG. 1, Row N transmitter has: 30 is the first element laser transmitter, 31 is the second element laser transmitter, 32 is (M-1) element laser transmitter, and 33 is M element laser transmitter of row N.

FIG. 1, Row N receiver has: 40 is the first element laser receiver, 41 is the second element laser receiver, 42 is (M-1) element laser receiver, and 43 is M element laser receiver of row N.

FIG. 2, 200 is the first row of RF transmit and receiver.

FIG. 2, 210 is the first row of Laser transmit and receiver.

FIG. 2, 220 is the first row N of RF transmit and receiver.

FIG. 2, 230 is the first row N of Laser transmit and receiver.

FIG. 3, 300 is the radar site location number 1.

FIG. 3, 310 is the radar site location number 2.

FIG. 3, 320 is the radar site location number 3.

What I claim as my invention is:

1. Structure phase array Laser and RF panel interlaces.

2. Enhance detection the stealthy objects by using laser array.
